(19) United States
(12) Patent Application Publication
(10) Pub. No.: US 2003/0223044 A1
(43) Pub. Date: Dec. 4, 2003

(54) LIGHT VALVE PROJECTION SYSTEM

(75) Inventor: Peter J. Janssen, Scarborough, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/161,799

(22) Filed: Jun. 4, 2002

(51) Int. Cl. G03B 21/14

(52) U.S. Cl. 353/20

(57) ABSTRACT

An optical apparatus comprises a reflective liquid crystal (LC) panel, and an optical device. The optical device forms an image at an image plane located between the optical device and a projection lens. The image is substantially free of Seidel aberrations.

### FIELD OF THE INVENTION

The present invention relates generally to liquid crystal (LC) display, and particularly to a reflective LC projector imaging apparatus.

### BACKGROUND AND SUMMARY

Liquid crystal technology has been applied in projection displays for use in projection televisions, computer monitors, point of sale displays, and electronic cinema to mention a few applications.

A more recent application of LC devices is the reflective LC display on a silicon substrate. Silicon-based reflective LC displays often include an active matrix of complementary metal-oxide-semiconductor (CMOS) transistors/switches that are used to selectively rotate the axes of the liquid crystal molecules.

The molecules of the liquid crystal are optically anisotropic. When the CMOS transistors are in an ‘on’ state, the associated electric field can rotate the molecules to be oriented parallel with the field. When oriented in this manner, the effects of the anisotropic optical properties of the LC are at a minimum. Stated differently, in this rotated state, the LC molecules have very little effect on the state of polarization of light that traverses the LC medium.

However, when the CMOS transistor is in an ‘off’ state, the effects of the anisotropic properties of the LC molecules are at a maximum, and have the greatest effect on the state of polarization of light that traverses the LC medium.

By the selective switching of the transistors in the array, the LC medium can be used to modulate the light with image information. This modulated light can then be imaged on a screen by projection optics thereby forming the image or picture.

The reflective LC display (often referred to as a panel) is desirably small, on the order of approximately 3 cm², while the viewing screen of the television, etc. is desirably large. For example, the viewing screen of a rear projection television has an area of approximately 1 m²; and the viewing screen of a home theater front projector has an area of approximately 5 m².

In view of the disparity between the area of the panel and the area of the viewing screen, it is often necessary to magnify the light from the panel significantly to project the image on the comparatively large viewing screen. To achieve this desired magnification, one must have a lens with a short back focal length, because the projection path length is usually predetermined, being dictated by the cabinet size in case of a TV or the distance between projector and screen in the case of a front projector.

Conflicting with the desire to have a projection lens with a relatively small focal length is the need in typical systems to have certain devices located between the panel and the projection lens. For example, it is often necessary to have a polarization discriminating device and an LC compensator between the panel and the projection lens. The placement of such devices increases the free working distance of the LC projection assembly, which is the distance between the LC panel and the backside of the barrel of the projection lens, to an extent that it becomes larger than the backside focal length of the lens.

Certain known lenses have been used to overcome the problem of the relatively large free working distance in LC projector applications. Unfortunately, known projection lenses are complex lens structures that are expensive. Therefore, long free working distance lenses of this type are not desirable in many applications. Other known lenses used to avoid the problem of the relatively long free working distance result in unacceptable curvature of the optical field, and/or other optical aberrations, which reduce the image quality at the screen. Therefore, these known lenses are not desirable.

What is needed, therefore, is an optical apparatus that overcomes at least the drawbacks associated with known projection systems for PC panels described above.

In accordance with an exemplary embodiment of the present invention, an optical apparatus comprises a reflective liquid crystal panel, and an optical device. The optical device forms an image at an image plane located between the optical device and a projection lens. The image is substantially free of Seidel aberrations.

### BRIEF DESCRIPTIONS OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 shows a projection lens system in a reflective LC device in accordance with an exemplary embodiment of the present invention.

FIG. 2 shows a projection lens system in a reflective LC device in accordance with another exemplary embodiment of the present invention.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

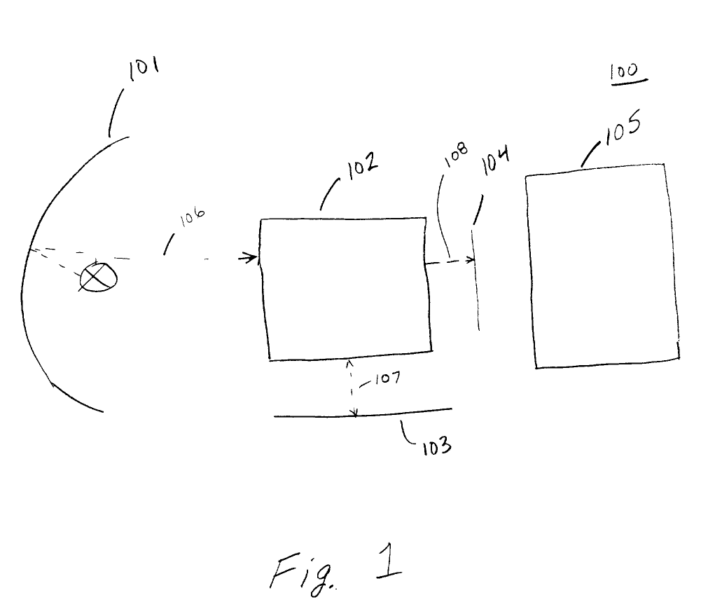

FIG. 1 shows a reflective LC projection system 100 in accordance with an exemplary embodiment of the present invention. The system 100 includes a lamp 101, an optical device 102, a reflective liquid crystal panel 103, and a projection lens 105. The optical device 102 may include optical elements for forming a lx image of the LC panel 103 at a back focal plane of the projection lens 105 (thereby forming a virtual object for magnification by the projection lens). Additionally, the optical device 102 may include elements that effect polarization discrimination (e.g., a polarization beamsplitter, polarizers, etc.), which may be useful in LC projection systems.

The reflective LC panel (also known as an LC light valve) 103 illustratively includes a nematic liquid crystal layer, electrical circuits (e.g. CMOS switch circuits) integrated with the panel, internal layers, cover glass and other devices used to form a plurality of pixels in an array.

The projection lens 105 has a relatively short back focal length, illustratively in the range of approximately 10 mm and 35 mm. The projection lens 105 is used to project a significantly magnified image of the LC panel 103 onto a screen (not shown). Because the lamp 101, the reflective LC panel 103, and the projection lens 105 are well within the purview of one of ordinary skill in the art, further details thereof are omitted in the interest of brevity.

In accordance with this and other exemplary embodiments described herein, the optical device 102 enables the projection lens to suitably magnify the LC panel 103, in spite of the relatively large free working distance. As mentioned previously, the relatively large free working distance in many LC projection systems results the required disposition of certain elements between the LC panel and the projection lens. Moreover, these elements can be relatively large. For example, in order to provide suitable contrast, an LC panel is usefully illuminated with telecentric light. This results in the expansion of the illuminating and reflected beams in the direction away from the LC panel. The optical device 102 must, therefore, be larger than the LC panel dimension in order to accommodate these expanding beams (a typical divergence angle is 10-15 degrees). Ultimately, this can increase the free working distance in many LC projection systems.

As described in detail through exemplary embodiments, to overcome the problems presented by the relatively large free working distance in many LC projection systems, a 1× image of the LC panel is formed at the back focal plane of the projection.

Light beam 106 from the lamp 101 is incident on the optical device 102. The light 106 from the lamp is usefully linearly polarized and uniform. This may be effected using a beam homogenizer and a polarizer (not shown in FIG. 1). The optical device 102 transmits light beam 107 to the reflective LC panel telecentrically so off-axis birefringent effects of the liquid crystal medium can be substantially avoided. The light beam 107 is reflected back from the LC panel in a manner described presently.

As referenced previously, the CMOS switches of the reflective LC panel 103 effect modulation of the light that traverses the panel. Some of the light reflected back from the LC panel 103 is transformed from one linear state of polarization to another (orthogonal) linear state of polarization, while some is reflected remaining in it original state of polarization. For example, if the light 106 were s-polarized light, it could emerge from the LC panel as s-polarized light or p-polarized light. The former case pertains to unmodulated light, while the latter is modulated light.

The modulated light is then transmitted by the optical element 102 as optical beam 108, and is ultimately imaged on the screen as a ‘bright’ pixel. Contrastingly, the unmodulated light emerges from the LC panel 103 in its original state of polarization, and is not imaged at the image plane 104. This unmodulated light forms a ‘dark’ pixel on the screen. Further details of the use of an LC medium to effect polarization transformation for modulating an optical signal to form an image on a screen may be found in “Effect of Liquid Crystal Electrical Anisotropy on Color Sequential Display Performance” by P. Janssen, Projection Displays I, SPIE Proceedings 2407, pp. 149-166; 1995. The disclosure of this article is specifically incorporated herein by references and for all purposes.

The optical device 102 transmits optical beam 108 that forms a virtual object for the projection lens at the image plane 104. This image plane 104 is located at the back focal length of the projection lens 105. Advantageously, the optical device 102 allows the use of a short focal length projection lens in reflective LC panel applications; thereby avoiding the drawbacks associated with the relatively long working distance of known reflective LC panel-based projection systems.

Characteristically, the optical element 102 selectively images light from the reflective LC panel 103 substantially with unit magnification and substantially without Seidel aberrations. Ultimately, this enables the projection of the image onto the screen substantially without the deleterious effects of these aberrations. Beneficially, the optical element 102 fosters improved image quality and at a reduced cost in reflective LC panel projection systems, because a relatively short back focal length projection lens (which has a relatively low cost compared to long back focal length projection lens) may be used.

As referenced, it is often necessary to have certain devices between the reflective LC panel and the projection lens, which is used for magnification of the image on the screen. One such device commonly used in reflective LC projection schemes is a polarization beamsplitter (PBS), which is one type of polarization discriminator. In LC projection applications, the PBS may be used to transmit light of one linear polarization state to the screen, and to prevent light of another linear polarization state from being transmitted to the screen. (Because polarization beam splitters are known to one having ordinary skill in the art, further details thereof are omitted in the interest of brevity of discussion). As will become clearer as the present description proceeds, the transmitted linearly polarized light projects a ‘bright’ pixel to the screen; and the linearly polarized light that is prevented from reaching the screen becomes a ‘dark’ pixel thereon.

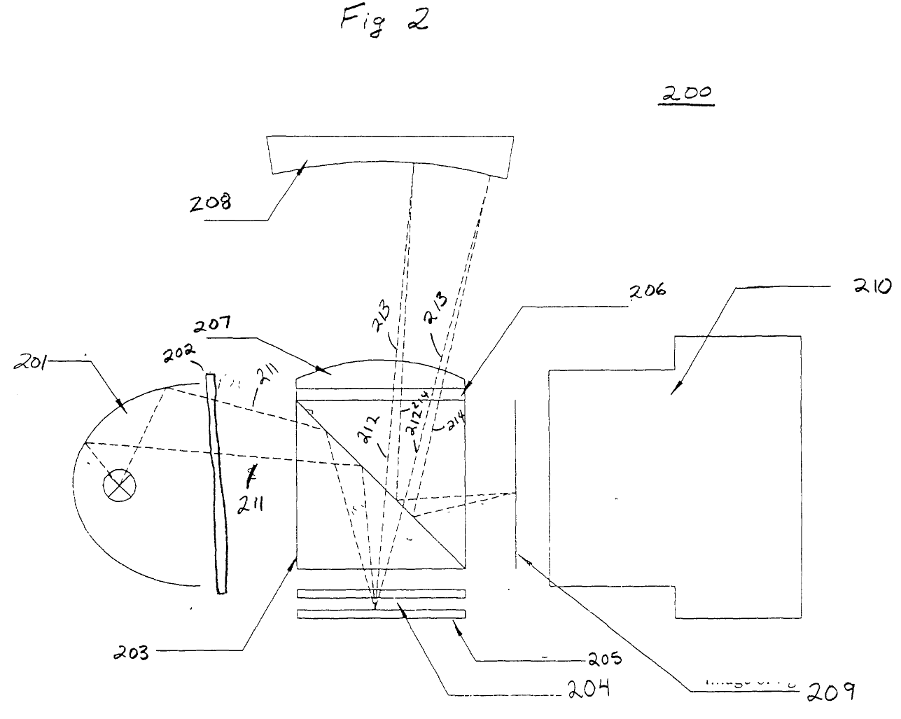

FIG. 2 shows a reflective LC projection system 200 in accordance with another exemplary embodiment of the present invention. The system 200 includes a lamp 201, a polarizer 202, a PBS 203, an LC compensator 204, and an LC panel 205.

The system 200 also includes a quarter wave plate 206, a plano-convex lens 207, and a mirror 208. As described in more detail below, the plano-convex lens 207 and the mirror form a Dyson relay (named after its inventor), which is described in “Unit Magnification Optical System without Seidel Aberrations,” by J. Dyson; Journal of the Optical Society of America, Vol. 49, No. 7 (July 1959), the disclosure of which is specifically incorporated herein by reference.

Light of a particular linear state of polarization is imaged at an image plane 209, forming a virtual object for a projection lens 210, which images the virtual object on a screen, not shown in FIG. 2. Beneficially, the image plane 209 is located at the back focal length of the projection lens 210. As described in connection with the exemplary embodiment shown in FIG. 1, and as will be described below in connection with the present exemplary embodiment, the back focal length of the projection lens 210 is relatively short. This comparatively short focal length projection lens is less complex and less expensive than long back focal length projection lenses used in known structures to accommodate for the relatively long working distance created by the inclusion of the BPS in the reflective LC projection system.

Additionally, by virtue of the Dyson relay, Seidel aberrations are substantially avoided to first order approximation. To this end, the Dyson relay is a symmetrical optical system (i.e., symmetric about a central plane). As will become more clear as the present description proceeds, light that traverses such a symmetrical optical system is ‘folded’ onto itself, meaning that light that traverses the elements of the symmetrical optical system in a forward direction will traverse the same elements in the backward direction. This symmetry substantially eliminates Seidel aberrations in the image of the symmetrical optical system.

Light from the lamp 201 traverses a linear polarizer 202, which transmits a linearly polarized light 211. (For purposes of discussion the linearly polarized light 211 is s-polarized light). The PBS 203 is chosen to reflect light that is linearly polarized in the same state as linearly polarized light 211. As such, the s-polarized light of the present exemplary embodiment is reflected by the PBS 203, and is incident telecentrically on the LC panel 205. The liquid crystal of the LC panel 205 is modulated by voltage sources (illustratively CMOS transistor switches) in a manner well known to one of ordinary skill in the art. As is known to one having ordinary skill in the art, the LC compensator 204 is used to enhance contrast if the drive voltage is insufficient to create a non-birefringent state of the liquid crystal. As can be readily appreciated the LC compensator is yet another element that can further increase the distance between the back focal plane of the projection lens.

As referenced previously, depending on the type of crystal, voltage-induced birefringence can be used to alter the state of polarization of light that traverses the LC twice (once in the incident direction, and once in the reflected direction). In the illustrative embodiment described in connection with FIG. 2, in regions where the CMOS transistor switches are in an ‘off’ state, the s-polarized light is transformed by the birefringent liquid crystal. Usefully, the orientation of the crystal and the thickness of the medium result in the LC panel 205 introducing a relative phase shift of π/2 between the ordinary and extraordinary components of the light. Stated differently, in regions where the CMOS transistors are in an ‘off’ state, the LC panel 205 acts like a quarter wave plate. As such, s-polarized light that traverses the medium twice by reflection emerges from the liquid crystal as p-polarized light 212, by the introduction of a relative phase difference of π radians between the ordinary and extraordinary waves. Contrastingly, in those regions of the LC panel 205 where the CMOS transistor switches are in an ‘on’ state, the LC medium behaves optically isotropically, and light s-polarized light that is incident in theses regions traverses the LC compensator 204 twice and emerges as s-polarized light having undergone no polarization transformation.

The light that has been transformed from s-polarized to p-polarized is said to have been modulated by the LC panel 205. This light is to be projected by the projection lens 210 onto the screen as a ‘bright’ pixel. The PBS 203 transmits the p-polarized light 212 therethrough. Contrastingly, s-polarized light, which remains in this polarization state, is reflected by the PBS 203 back toward the lamp 201. The absence of this light at the screen results in a ‘dark’ pixel thereon. As the liquid crystal is disposed over the LC panel 205, which includes the reflective elements and CMOS transistor in an order array, the image of the reflected light from the LC panel 205 forms a pattern of bright and dark pixels on the screen and thereby a the desired picture. Again further details of this imaging process using an LC medium may be found in the above article to P. Janssen.

The p-polarized light 212 traverses a quarter-wave plate 206 for reasons that will be discussed herein. The p-polarized light emerges from the quarter wave plate as circularly polarized light 213, and is focused on the mirror 208 by the plano-convex lens 207. The circularly polarized light 213 is reflected by the mirror, is imaged in the conjugate by the combined action of mirror 208 and plano-convex lens 207, and undergoes a further rotation by the quarter-wave plate 206, emerging as s-polarized light 214. The s-polarized light 214 is reflected by the PBS 203 and is imaged at the image plane 209. This image becomes the virtual object of the projection lens 210.

As can be readily appreciated from a review of the above imaging process, the quarter wave plate 206 usefully transforms the light from the p-polarized state to the s-polarized state so that it is reflected by the PBS 203 and imaged at the image plane. In this manner, the PBS 203 and the quarter wave plate enable light modulated by the LC compensator (in the p-state) to be imaged on the screen. It is noted that the PBS 203 and quarter wave plate 206 are merely illustrative devices for achieving that end. It is noted that other devices used to achieve this desired polarization discrimination/selection and polarization transformation achieved by the PBS 203 and the quarter wave plate 206, respectively, may be used. Such devices are within the purview of one having ordinary skill in the art.

As mentioned above, the plano-convex lens 207 and the mirror 208 form a Dyson relay. The Dyson relay comprised of the plano-convex lens 207 and the mirror 208 advantageously forms a unit magnification imaging system substantially without Seidel aberrations. The mirror 208 illustratively has a radius of curvature R, and the convex surface of the plano-convex lens 207 has a radius of curvature, r. The central thickness of the plano-convex lens is such that the center of the curvature of the convex surface lies on the flat side.

When used in the LC projection system 200 of the presently described embodiment, the Dyson relay enables an object (in this case the reflective LC panel 205) to be imaged with unit magnification coincident with itself at the image plane 209, forming a real image that can serve as a virtual object for further imaging. Advantageously, the virtual object formed at the image plane is placed in close proximity to the projection lens, thereby enabling the use of a lens with a short back focal length. This fosters a reduction in cost in a system having a relatively large working distance, without the deleterious effects of Seidel aberrations.

As referenced above and as described in the article to Dyson, the Dyson relay achieves unit magnification. Because of the unit magnification, symmetry is realized, and the light reflected from the mirror 208 traverses the plano-convex lens in reverse, and there is a canceling of first order aberrations. As such, while the Dyson relay is described in connection with the projection lens system 200 of the exemplary embodiment of FIG. 2, it is noted that other devices which can achieve the desired end of forming a 1× image substantially free of Seidel aberrations at a back focal plane of a projection lens having a short back focal length may be used.

The invention having been described in detail in connection through a discussion of exemplary embodiments, it is clear that modifications of the invention will be apparent to one having ordinary skill in the art having had the benefit of the present disclosure. Such modifications and variations are included in the scope of the appended claims.

1. An optical apparatus, comprising:
a reflective liquid crystal panel; and
an optical device, which forms an image which is substantially free of Seidel aberrations
at an image plane located between said optical device and a projection lens.

2. An optical apparatus as recited in claim 1, wherein said optical device further includes a polarization discriminator.

3. An optical apparatus as recited in claim 1, wherein said optical device further includes a polarization beam splitter.

4. An optical apparatus as recited in claim 1, wherein said optical device further includes at least one optical element, and said image has unit magnification.

5. An optical apparatus as recited in claim 1, wherein said image is a virtual object.

6. An optical apparatus as recited in claim 4, wherein said image is of selected portions of said liquid crystal panel.

7. An optical apparatus as recited in claim 6, wherein light of said image is in a first state of linear polarization.

8. An optical apparatus as recited in claim 1, wherein said optical device further comprises a quarter wave plate.

9. An optical apparatus as recited in claim 1, wherein said projection lens has a back focal length in the range of approximately 10 mm to approximately 35 mm.

10. An optical apparatus, comprising:
a reflective liquid crystal panel; and
a Dyson relay.

11. An optical apparatus as recited in claim 10, further comprising a projection lens.

12. An optical apparatus as recited in claim 11, further comprising an optical device between said liquid crystal panel and said Dyson relay.

13. An optical apparatus as recited in claim 11, wherein said Dyson relay forms an image at an image plane that is located between said optical device and said projection lens.

14. An optical apparatus as recited in claim 12, wherein said optical device further comprises a polarization discriminator.

15. An optical apparatus as recited in claim 12, wherein said optical device further comprises at least one polarizer.

16. An optical apparatus as recited in claim 12, wherein said optical apparatus further comprises a polarization beam splitter and a quarter-wave plate.

17. An optical apparatus as recited in claim 13, wherein said image plane and said liquid crystal panel are not parallel.

18. An optical apparatus as recited in claim 11, wherein said projection lens has a back focal length in the range of approximately 10 mm to approximately 35 mm.

19. An optical apparatus as recited in claim 13, wherein said image is substantially free of Seidel aberrations.

20. An optical apparatus as recited in claim 13, wherein said image plane and said liquid crystal panel are substantially orthogonal.
